(19) United States
(12) Patent Application Publication
(10) Pub. No.: US 2012/0093218 A1
(43) Pub. Date: Apr. 19, 2012

(54) ADAPTIVE MULTIMEDIA DECODING DEVICE AND METHOD FOR SCALABLE SATELLITE BROADCASTING

(75) Inventors: Dae Ig CHANG, Daejeon (KR); Seung Chul Kim, Daejeon (KR); Tae Gyu Chang, Seoul (KR); Shin Wook Kim, Seoul (KR); Hyeon Jin Jeon, Seoul (KR); Woo Gun Lee, Seoul (KR)

(73) Assignee: ELECTRONICS AND TELECOMMUNICATIONS RESEARCH INSTITUTE, Daejeon (KR)

(21) Appl. No.: 13/276,588

(22) Filed: Oct. 19, 2011

(30) Foreign Application Priority Data
Oct. 19, 2010 (KR) 10-2010-0101990

(51) Int. Cl. H04N 7/26

(52) U.S. Cl. 375/240.02; 375/E07.126

(57) ABSTRACT

Disclosed is an adaptive multimedia decoding device and method for scalable satellite broadcasting. A TS decoder TS-decodes a first transmission stream and a second transmission stream received through different transmission bands to generate a first video stream, a second video stream, and an audio stream. A first decoder and a second decoder are configured of a plurality of operation modules that are sequentially performed so as to decode the first video stream, the second video stream, and the audio stream and are independently controlled and are operated in parallel. A controller compares the amount of data corresponding to one input unit of the first video stream and the second video stream input to each of the first decoder and the second decoder, to selectively perform each operation module configuring the first decoder and the second decoder whenever the data corresponding to one input unit are input.

### CROSS-REFERENCE TO RELATED APPLICATIONS

This application claims priority under 35 U.S.C. §119 to Korean Patent Application No. 10-2010-0101990, filed on Oct. 19, 2010, in the Korean Intellectual Property Office, the disclosure of which is incorporated herein by reference in its entirety.

### TECHNICAL FIELD

The present invention relates to an adaptive multimedia decoding device and method for scalable satellite broadcasting, and more particularly, to a device and a method for demodulating and decoding a base layer stream transmitted through a Ku frequency band and an enhancement layer stream transmitted through a Ka frequency band in quality selective satellite broadcasting services.

### BACKGROUND

When intelligent broadcasting contents are provided under broadcasting and telecommunication convergence environment, there is a need to provide optimal services in various network environments and various terminals. To this end, scalable video coding (SVC), which is an implementable method, is a video coding technology of configuring a single bit stream for a single video content to have various spatial resolutions and qualities and various frame rates so as to enable several terminals to receive and recover bit streams according to their own ability. A H.264/SVC standard associated with the scalable video coding has been developed to supplement disadvantages of coding efficiency degradation included in similar technology standards according to the related art based on the H.264/AVC.

As a band in which satellite broadcasting services may be provided using the scalable video coding method, there are a Ku band and a Ka band. In this case, a stream of a base layer of the H.264/SVC standard is transmitted through a Ku frequency band (12 to 14 GHz) and a stream of an enhancement layer is transmitted through a Ka frequency band (20 to 30 GHz).

Herein, unlike the Ku band that has been widely used as the existing satellite broadcasting service band, the Ka band forms a spot beam while providing a wider band of frequency resources, thereby increasing reusability of a frequency. However, the Ku band may be very fatal to the effect of a heavy rainfall.

When demodulating the base layer stream and the enhancement layer stream, the case in which the computations thereof are unbalanced may frequently occur. Even though a demodulation of one of the base layer stream and the enhancement layer stream is completed, the demodulation is not performed until the demodulation of the other layer stream is completed. As a result, a demodulation rate may be generally degraded.

Therefore, in the multimedia decoding device for satellite broadcasting receiving and demodulating the streams for satellite broadcasting, a need exists for a method for increasing a demodulation rate while responding to a sudden change in a Ka frequency band channel due to the worsening of weather conditions.

### SUMMARY

An exemplary embodiment of the present invention provides an adaptive multimedia decoding device for scalable satellite broadcasting, including: a TS decoder TS-decoding a first transmission stream and a second transmission stream received through different transmission bands to generate a first video stream, a second video stream, and an audio stream; a first decoder and a second decoder configured of a plurality of operation modules that are sequentially performed so as to decode the first video stream, the second video stream, and the audio stream and are independently controlled and operated in parallel; and a controller comparing the amount of data corresponding to one input unit of the first video stream and the second video stream input to the first decoder and the second decoder, respectively, to selectively perform each operation module configuring the first decoder and the second decoder whenever the data corresponding to the one input unit are input.

Another exemplary embodiment of the present invention provides an adaptive multimedia decoding method for scalable satellite broadcasting, including: TS-decoding a first transmission stream and a second transmission stream received through different transmission bands to generate a first video stream, a second video stream, and an audio stream; comparing the amount of data corresponding to one input unit of the first video stream and the second video stream input to the first decoder and the second decoder, respectively; and selectively performing each operation module configuring the first decoder and the second decoder whenever the data corresponding to the one input unit are input.

Other features and aspects will be apparent from the following detailed description, the drawings, and the claims.

### BRIEF DESCRIPTION OF THE DRAWINGS

FIG. 1 is a diagram showing a configuration of a transmitting and receiving system for providing quality selective satellite broadcasting services through different frequency bands.

FIG. 2 is a block diagram showing a configuration of an adaptive multimedia decoding device for scalable satellite broadcasting according to an exemplary embodiment of the present invention.

FIG. 3 is a diagram showing an example of an operation module selected so as to be performed in a first decoder and a second decoder according to computations of an enhancement layer stream and a base layer stream according to the exemplary embodiment of the present invention.

FIG. 4 is a flow chart showing a process of performing the adaptive multimedia decoding method for scalable satellite broadcasting according to the exemplary embodiment of the present invention.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

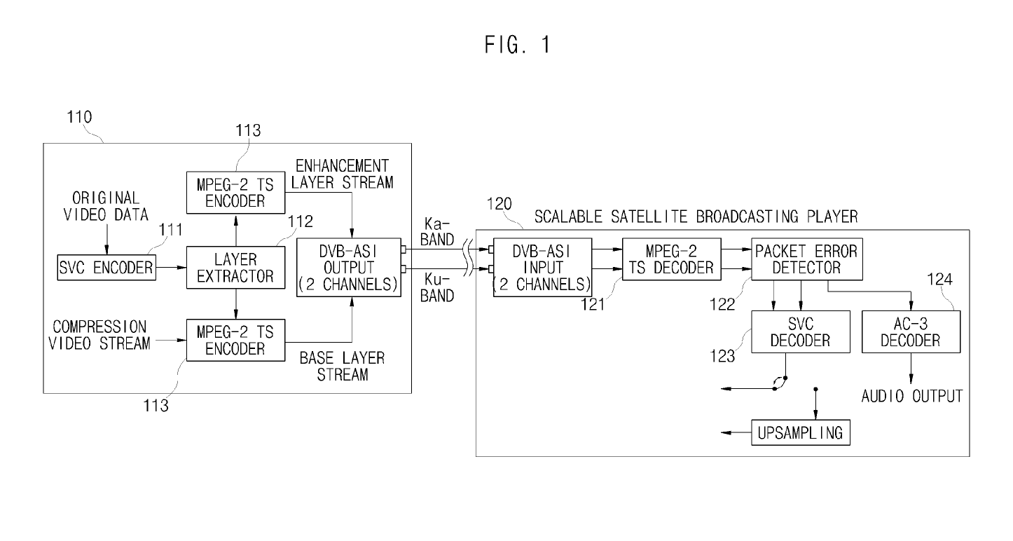

A transmitting and receiving system to which an adaptive multimedia decoding device and method for scalable satellite broadcasting according to an exemplary embodiment of the present invention are applied will be described with reference to FIG. 1. FIG. 1 is a diagram showing a configuration of a transmitting and receiving system for providing quality selective satellite broadcasting services through different frequency bands.

Referring to FIG. 1, the transmitting and receiving system to which the adaptive multimedia decoding device and method for scalable satellite broadcasting are applied is configured to include a scalable satellite broadcasting transmitter 110 that generates and transmits broadcasting data and a scalable satellite broadcasting decoding device 120 that receives and decodes streams from two channels.

The scalable satellite broadcasting transmitter 110 uses a H.264/SVC compression method in an SVC encoder 111 to generate streams having two spatial resolutions from video data and uses a layer extractor 112 to transmit a base layer stream through a Ku band and an enhancement layer stream through a Ka band.

Each stream is packetized into a MPEG-2 Packetize Element Stream (PES). In this case, in order to synchronize each layer stream) with an audio stream, a decoding time stamp (DTS) is inserted. The PES packet is encoded into an MPEG-2 TS stream in an MPEG-2 TS encoder 113 and is transmitted and the basic layer stream includes the audio stream.

The Ts streams of the base layer and the enhancement layer each transmitted through the Ku band and the Ka band are received to the scalable satellite broadcasting decoding device 120 and a TS decoder 121 of the multimedia decoding device 120 extracts the video stream and the audio stream from the TS streams. Each packet of the extracted streams passes through an error detector 122 and the video stream is demodulated and decoded by the SVC decoder 123 and the audio stream is demodulated and decoded by an AC-3 decoder 124.

The adaptive multimedia decoding device and method for scalable satellite broadcasting according to the exemplary embodiment of the present invention are used to demodulate the base layer stream and the enhancement layer stream. Therefore, it is conditioned that the transmission streams received in the exemplary embodiment of the present invention are received through different transmission bands.

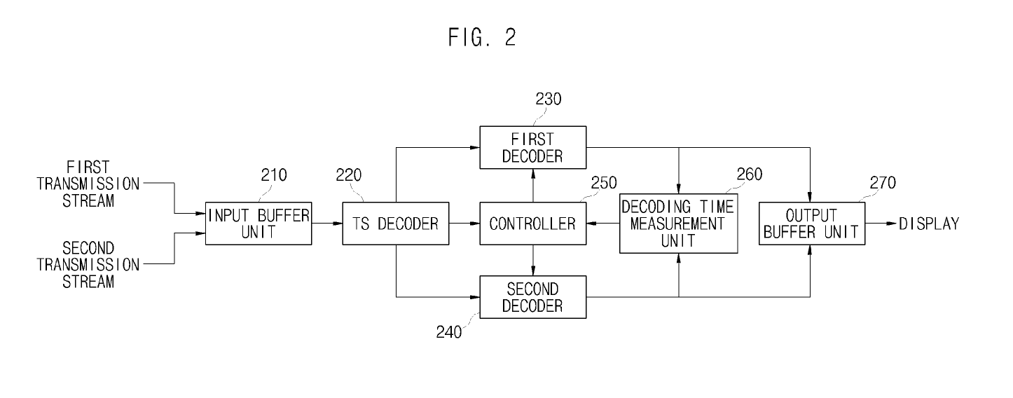

The adaptive multimedia decoding device for scalable satellite broadcasting according to the exemplary embodiment of the present invention will be described with reference to FIG. 2. FIG. 2 is a block diagram showing a configuration of an adaptive multimedia decoding device for scalable satellite broadcasting according to an exemplary embodiment of the present invention.

Referring to FIG. 2, the adaptive multimedia decoding device of scalable satellite broadcasting according to the exemplary embodiment of the present invention includes an input buffer unit 210, a TS decoder 220, a first decoder 230, a second decoder 240, a controller 250, a decoding time measurement unit 260, and an output buffer unit 270.

The input buffer unit 210 is stored with a first transmission stream and a second transmission stream received through different transmission bands.

As described with reference to FIG. 1, the transmission streams of the base layer stream and the enhancement layer stream generated by the scalable satellite broadcasting transmitter are transmitted through the Ku band and the Ka band that are different transmission bands. The transmission stream transmitted as described above is received to the adaptive multimedia decoding device for scalable satellite broadcasting according to the exemplary embodiment of the present invention.

Therefore, the first transmission stream and the second transmission stream stored in the input buffer unit 210 may each be the transmission stream for the base layer stream received through the Ku band and the transmission stream for the enhancement layer stream received through the Ka band. Meanwhile, the audio stream is included in the first transmission stream together with the base layer stream.

The TS decoder 220 TS-decodes the first transmission stream and the second transmission stream to generate a first video stream, a second video stream, and an audio stream. In this case, the first video stream and the audio stream each are the base layer stream and the audio stream that are included in the first transmission stream transmitted through the Ku band and the second video stream corresponds to the enhancement layer stream included in the second transmission stream transmitted through the Ka band.

The first decoder 230 is configured of a plurality of operation modules independently performing each process necessary for the decoding of the base layer stream and the audio stream and the first video stream and the audio stream generated from the first transmission stream are decoded by the plurality of operation modules.

The second decoder 240 is configured of a plurality of operation modules independently performing each process necessary for the decoding of the enhancement layer stream and the second video stream generated from the second transmission stream is decoded by the plurality of operation modules.

In this case, the first decoder 230 and the second decoder 240 are configured of the plurality of operation modules that are sequentially performed so as to decode the first video stream, the second video stream, and the audio stream and may be independently controlled and operated in parallel. Therefore, the first decoder 230 and the second decoder 240 may have the same configuration and may be simultaneously operated.

However, it is impossible to simultaneously operate the same operation modules included in the first decoder 230 and the second decoder 240 and only the selected one operation module may be operated. The data to be processed cannot be simultaneously input to the plurality of operation modules.

As described above, the function of selecting which one of the operation modules is operated in the first decoder 230 and the second decoder 240 is performed by the controller 250.

The controller 250 compares the amount of data corresponding to one input unit of the first video stream and the second video stream each input to the first decoder 230 and the second decoder 240 to selectively perform each of the operation modules configuring the first decoder 230 and the second decoder 240 whenever the data corresponding to one input unit are input.

For example, when the first video stream and the second video stream are input to the first decoder 230 and the second decoder 240 in one frame unit, the amount of data of the first decoder 230 and the second decoder 240 does not necessarily the same. That is, the amount of data of the enhancement layer stream corresponding to the second video stream is larger than the amount of data of the base layer stream corresponding to the first video stream, such that the demodulation time is generally long.

Therefore, the controller 250 may perform a control to perform only the operation modules for demodulating the enhancement layer stream in the second decoder 240 and to perform both of the operation modules for performing the decoding of the audio stream and the base layer stream in the first decoder 230 and the upsampling the decoded base layer stream.

However, the amount of data corresponding to one frame is not constant and therefore, the amount of data of the base layer stream may be larger than the amount of data of the enhancement layer stream. In this case, the controller 250 compares the amount of data whenever the data of the base layer stream and the enhancement layer stream corresponding to one frame are input to the first decoder 230 and the second decoder 240 to select the operation modules to be performed in the first decoder 230 and the second decoder 240.

That is, when the amount of data of the enhancement layer stream is larger, more operation modules may be performed in the first decoder 230 and when the amount of data of the base layer stream is larger, more operation modules may be performed in the second decoder 240.

However, as described above, the same operation modules may not be set to be simultaneously performed in both of the first decoder 230 and the second decoder 240.

However, since the decoding processing rates of the first decoder 230 and the second decoder 240 are not necessarily the same, there may be a case in which determining the operation modules to be performed by comparing only the amount of data input to both of the first decoder 230 and the second decoder 240 is not appropriate.

Therefore, the adaptive medium decoding device for scalable satellite broadcasting according to the exemplary embodiment of the present invention further includes a decoding time measurement unit 260 to measure the decoding time consumed to decode one frame in the first decoder 230 and the second decoder 240, respectively.

That is, the decoding of the base layer stream and the enhancement layer stream corresponding to one frame is first performed in the first decoder 230 and the second decoder 240, respectively. Thereafter, the decoding time is measured in the first decoder 230 and the second decoder 240, which is input to the controller 250 for feedback.

The controller 250 calculates the computations required to decode the first video stream and the second video stream based on the amount of data and the decoding time measured for the first decoder 230 and the second decoder 240, respectively.

In this case, the computation of the audio stream has a small weight in the overall computation and therefore, is not necessarily considered. In order to calculate the computation, an LMS algorithm may be used.

That is, the controller 250 considers the amount of data and the decoding rate to determine the operation modules to be performed in the first decoder 230 and the second decoder 240.

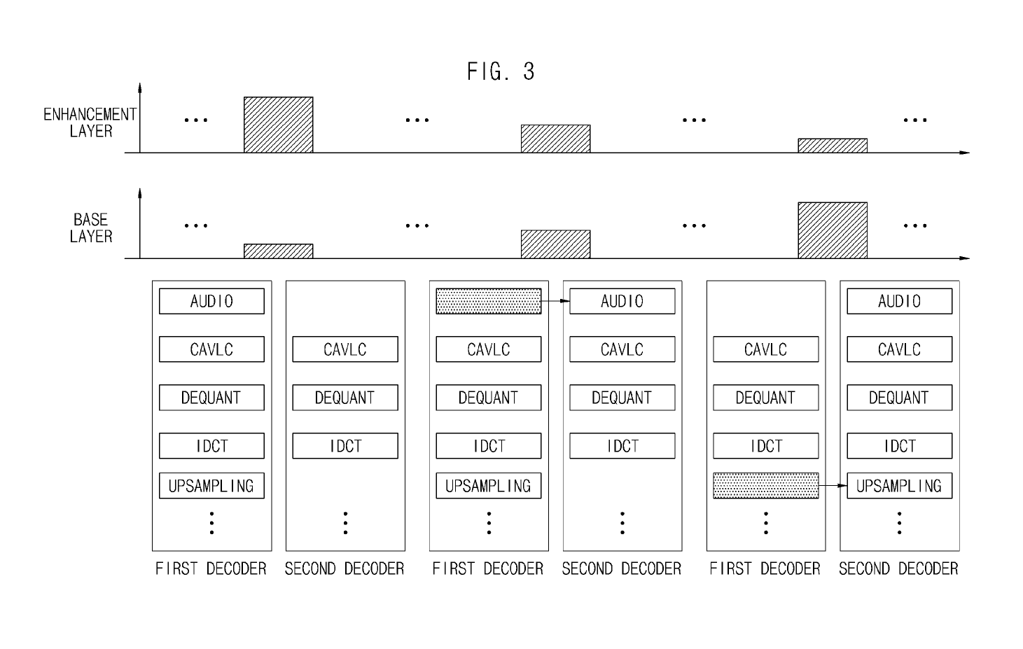

The operation modules selected so as to be performed in the first decoder and the second decoder according to the computations of the enhancement layer stream and the base layer stream according to the exemplary embodiment of the present invention will be described with reference to FIGS. 2 and 3. FIG. 3 is a diagram showing an example of the operation module selected so as to be performed in the first decoder and the second decoder according to the computations of the enhancement layer stream and the base layer stream according to the exemplary embodiment of the present invention.

Referring to FIGS. 2 and 3, the computations corresponding to one frame of the enhancement layer stream and the base layer stream are shown in a graph form and the operation modules included in each of the first decoder 230 and the second decoder 240 are shown. ‘Audio’ is an operation module for decoding the audio stream, ‘CAVLC’, ‘Dequant’, and ‘IDCT’ included in the first decoder 230 are an operation module for decoding the first video stream, that is, the base layer stream, ‘CAVLC’, ‘Dequant’, and ‘IDCT’ included in the second decoder 240 are an operation module for decoding the second video stream, that is, the enhancement layer stream, and ‘Upsampling’ is an operation module for upsampling the decoded base layer stream.

In FIG. 3, the leftmost case is a case in which the computation of the enhancement layer stream is remarkably larger than the computation of the base layer stream. In this case, the ‘Audio’ operation module for decoding the audio stream, the ‘CAVLC’, ‘Dequant’, and ‘IDCT’ operation modules for decoding the base layer stream, the ‘Upsampling’ operation module for upsampling are performed in the first decoder 230 and only the ‘CAVLC’, ‘Dequant’, and ‘IDCT’ operation modules for decoding the enhancement layer stream that is an operation module not performed in the first decoder 230 are performed in the second decoder 240, such that the first decoder 230 and the second decoder 240 may balance the processing time and the computation.

Since the operation modules may be sequentially performed within the single decoders 230 and 240, but the first decoder 230 and the second decoder 240 may be operated in parallel, the smaller number of operation modules selected so as to be performed in the second decoder 240 are sequentially performed while more operation modules are sequentially performed in the first decoder 230 and since the computation of the enhancement layer stream is large, the computations processed by the performance of the first decoder 230 and the second decoder 240 may be balanced.

Next, the intermediate case in FIG. 3 is the case in which the computation of the enhancement layer stream is similar to the computation of the base layer stream. Since this case is set to be the same as the left case of FIG. 3 described above, the operation modules of the first decoder 230 and the second decoder 240 may be performed.

As shown in FIG. 3, the controller 250 may stop the performance of the ‘Audio’ operation module set to be originally performed in the first decoder 230 and may perform the ‘Audio’ operation module of the second decoder 240.

The reason is that the computation of the audio stream has a smaller weight than the video stream such as the base layer stream and the enhancement layer stream and the computation processed by the second decoder 240 is not largely increased even when the ‘Audio’ operation module is performed in the second decoder 240.

Contrary to the left case of FIG. 3, the case shown in the right of FIG. 3 corresponds to the case in which the computation of the base layer stream is remarkably larger than the computation of the enhancement layer stream. In this case, the controller 250 may be performed in the second decoder 240 from the ‘Audio’ operation module to the ‘Upsampling’ operation module.

Therefore, while the decoding of the frame of the base layer stream is performed in the first decoder 230, the second decoder 240 may perform the decoding of the frame of the enhancement layer stream and the upsampling of the previous frame of the previously decoded base layer stream. The reason is that the first decoder 230 and the second decoder 240 may be operated in parallel.

The example described in FIG. 3 is only one exemplary embodiment of selectively performing the operation module according to the computations of the base layer stream and the enhancement layer stream and the determination of the operation modules to be performed in the first decoder 230 and the second decoder 240 may be changed according to the setting.

However, in the case of the upsampling, since the weight of the computation occupied during the overall demodulation process is very large by 25% or more, the controller 250 determines which decoder performs the operation module performing the upsampling to effectively control the computations processed by the first decoder 230 and the second decoder 240.

As described above, the controller 250 compares the computations of the base layer stream and the enhancement layer stream to determine the operation modules to be sequentially performed in the first decoder 230 and the second decoder 240, respectively.

The adaptive medium decoding device for scalable satellite broadcasting according to the exemplary embodiment of the present invention can reduce the standby time until the demodulation process is completed by another decoder after all the demodulation processes are completed by the single decoder, thereby improving the overall demodulation rate.

Meanwhile, the operation modules included in the first decoder 230 and the second decoder 240 may be selectively performed even when the transmission stream of the enhancement layer stream, that is, the second transmission stream is not received due to the comparison of the computations of the base layer stream and the enhancement layer stream and the attenuation of the Ka band.

That is, when the Ka band is attenuated due to the worsening of the weather conditions such as a heavy rainfall, the transmission stream of the enhancement layer stream received through the Ka band is interrupted. The front of the input buffer unit 210 is provided with the unit that senses the attenuation of the Ka band and interrupts the reception of the transmission stream corresponding thereto and when the reception of the enhancement layer stream is interrupted, the corresponding signal is transmitted to the controller 250.

When the enhancement layer stream is not received, the second decoder 240 is not used and the controller 250 may perform the operation modules of the second decoder 240 as an auxiliary unit for demodulating the base layer stream.

For example, only the operation modules for decoding the first video stream are performed in the first decoder 230 and the operation module for decoding the audio stream and the operation module for upsampling the decoded first video stream are performed in the second decoder 240.

The base layer stream and the enhancement layer stream decoded in each of the first decoder 230 and the second decoder 240 that are operated in the adaptive structure are stored in the output buffer unit 270 through the layer synchronization process and are output to the display device at a predetermined time interval.

During the layer synchronization process, when the decoding of the base layer stream is first completed, one NAL unit is read from the enhancement layer stream. When the DTSs of two layers are the same by comparing the DTS value inserted during generating the NAL unit of the enhancement layer as the PES packet and the DTS of the base layer decoded according to the related art, the decoding process of the enhancement layer is continued. When the DTS of the enhancement layer is smaller than the DTS of the base layer, the current enhancement layer NAL unit is discarded and the subsequent NAL unit is read from the buffer and then, the DTSs are compared again. When the DTS of the enhancement layer is larger than the base layer, there is no enhancement layer corresponding to the base layer, which is set to output results of decoding the base layer stream and initializes the decoding process of the enhancement layer.

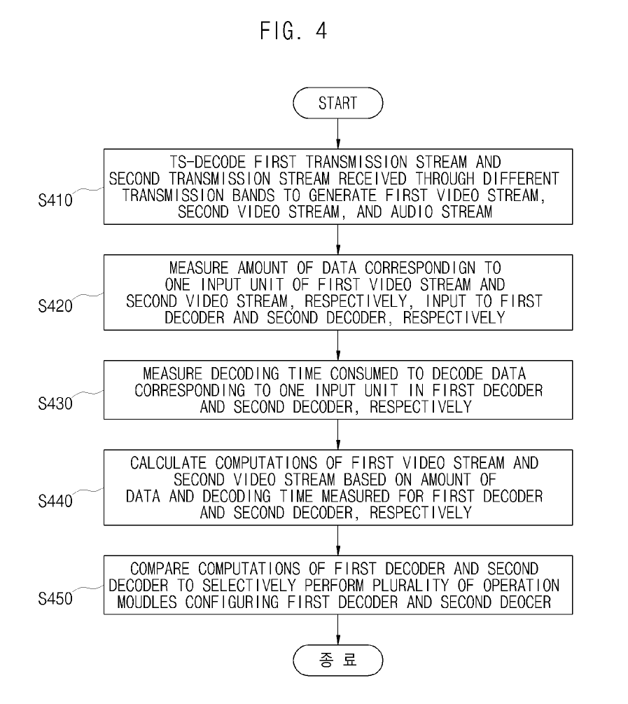

An adaptive multimedia decoding method for scalable satellite broadcasting according to another exemplary embodiment of the present invention will be described with reference to FIGS. 2 and 4. FIG. 4 is a flow chart showing a process of performing the adaptive multimedia decoding method for scalable satellite broadcasting according to the exemplary embodiment of the present invention.

The first transmission stream and the second transmission stream received through different transmission bands, that is, the transmission stream of the base layer stream and the transmission stream of the enhancement layer stream received through the Ku band and the Ka band, respectively, are stored in the input buffer unit 210 and then, TS-decoded in one input unit, that is, a frame unit by the TS decoder 220.

In this case, the TS decoder 220 TS-decodes the first transmission stream and the second transmission stream to generate the first video stream, the second video stream, and the audio stream (S410).

In this case, the first video stream is the base layer stream and the second video stream is the enhancement layer stream.

Next, the controller 250 measures the amount of data in the frame unit that is input to the first decoder 230 and the second decoder 240, respectively (S420). In this case, the controller 250 controls the operations of the plurality of operation modules that configures the first decoder 230 decoding the first video stream and the audio stream and the second decoder 240 decoding the second video stream, respectively.

Next, the decoding time measurement unit 260 measures the decoding time consumed to decode one frame in the first decoder 230 and the second decoder 240, respectively (S430).

Next, the controller 250 calculates the computations of the base layer stream and the enhancement layer stream based on the amount of data and the decoding time measured for the first decoder 230 and the second decoder 240, respectively, (S440) and compares the computations thereof to selectively perform the plurality of operation modules configuring the first decoder 230 and the second decoder 240, respectively (S450).

Meanwhile, the above-mentioned exemplary embodiments of the present invention can implement a computer-readable recording medium as a computer-readable code. The computer-readable recording medium includes all the types of recording devices in which the data readable by the computer system are stored. An example of the computer-readable recording medium may include ROM, RAM, CD-ROM, a magnetic tape, a floppy disk, an optical data storage device, or the like, and may include ones implemented in a carrier wave (for example, transmission through Internet) type. In addition, the computer-readable recording medium may be distributed in the computer system connected through the network and may be stored and executed with the computer-readable code in a distribution manner.

As set forth above, the adaptive multimedia decoding device and method for scalable satellite broadcasting according to the exemplary embodiments of the present invention include the decoder having the independent operation modules for decoding the respective video streams received through different transmission bands and selectively perform the operation modules included in two decoders to balance the computations of the base layer stream and the enhancement layer stream, thereby reducing the overall demodulation time and improving the performance of the multimedia decoding device.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An adaptive multimedia decoding device for scalable satellite broadcasting, comprising:
a first decoder and a second decoder including a plurality of operation modules sequentially performed and independently controlled so as to decode a first video stream, a second video stream, and an audio stream and operated in parallel; and
a controller selectively performing each of the operation modules configuring the first decoder and the second decoder.

2. The device of claim 1, wherein the controller compares the amount of data corresponding to one input unit of the first video stream and the second video stream each input to the first decoder and the second decoder to selectively perform each of the operation modules configuring the first decoder and the second decoder whenever the data corresponding to one input unit are input.

3. The device of claim 2, wherein the controller performs the operation module decoding the first video stream in the first decoder and performs the operation module decoding each of the second video stream and the audio stream and the operation module performing upsampling on the decoded first video stream in the second decoder, when the amount of data corresponding to one input unit of the first video stream is larger than the amount of data corresponding to one input unit of the second video stream.

4. The device of claim 2, wherein the controller performs the operation module decoding each of the first video stream and the audio stream and the operation module performing upsampling on the decoded first video stream in the first decoder, and performs the operation module decoding the second video stream in the second decoder, when the amount of data corresponding to one input unit of the second video stream is larger than the amount of data corresponding to one input unit of the first video stream.

5. The device of claim 1, further comprising a decoding time measurement unit measuring a decoding time consumed to decode data corresponding to one input unit of the first video stream and the second video stream, respectively, in the first decoder and the second decoder,
wherein the controller compares computations of the first video stream and the second video stream calculated based on the amount of data and the decoding time corresponding to the one input unit measured for the first decoder and the second decoder, respectively, to selectively perform the operation modules of the first decoder and the second decoder.

6. The device of claim 5, wherein the controller performs the operation module decoding the first video stream in the first decoder and performs the operation module decoding each of the second video stream and the audio stream and operation module performing the upsampling on the decoded first video stream in the second decoder, when computation of the first video stream is larger than computation of the second video stream.

7. The device of claim 5, wherein the controller performs the operation module decoding each of the first video stream and the second audio stream and the operation module performing the upsampling on the decoded first video stream in the first decoder and performs the operation module decoding the second video stream in the second decoder, when computation of the second video stream is larger than computation of the first video stream.

8. The device of claim 1, further comprising a TS decoder TS-decoding a first transmission stream and a second transmission stream received through different transmission bands to generate the first video stream, the second video stream, and the audio stream.

9. The device of claim 8, wherein the first video stream is a base layer stream received through a Ku transmission band and the second video stream is an enhancement layer stream received through a Ka transmission band.

10. The device of claim 9, wherein the controller performs the operation module decoding the first video stream in the first decoder and performs the operation module decoding the audio stream and the operation module performing the upsampling on the decoded first video stream in the second decoder, when the received second transmission stream is interrupted by attenuation of the Ka transmission band.

11. An adaptive multimedia decoding method for scalable satellite broadcasting, comprising:
TS-decoding a first transmission stream and a second transmission stream received through different transmission bands to generate a first video stream, a second video stream, and an audio stream;
comparing the amount of data corresponding to one input unit of the first video stream and the second video stream input to the first decoder and the second decoder, respectively; and
selectively performing each operation module configuring the first decoder and the second decoder whenever the data corresponding to the one input unit are input.

12. The method of claim 11, wherein the selectively performing includes performs the operation module decoding the first video stream in the first decoder and performs the operation module decoding each of the second video stream and the audio stream and the operation module performing upsampling on the decoded first video stream in the second decoder, when the amount of data corresponding to one input unit of the first video stream is larger than the amount of data corresponding to one input unit of the second video stream.

13. The method of claim 11, wherein the selectively performing performs the operation module decoding each of the first video stream and the audio stream and the operation module performing upsampling on the decoded first video stream in the first decoder, and performs the operation module decoding the second video stream in the second decoder, when the amount of data corresponding to one input unit of the second video stream is larger than the amount of data corresponding to one input unit of the first video stream.

14. The method of claim 11, further comprising measuring a decoding time consumed to decode data corresponding to one input unit of the first video stream and the second video stream, respectively, in the first decoder and the second decoder,
wherein the selectively performing includes comparing computations of the first video stream and the second video stream calculated based on the amount of data and the decoding time corresponding to the one input unit measured for the first decoder and the second decoder, respectively, to selectively perform the operation modules of the first decoder and the second decoder.

15. The method of claim 14, wherein the selectively performing performs the operation module decoding each of the first video stream and the audio stream, and the operation module performing the upsampling on the decoded first video stream in the first decoder and performs the operation module decoding the second video stream in the second decoder.

16. The method of claim 14, wherein the selectively performing performs the operation module decoding the first video stream in the first decoder and performs the operation module decoding each of the second video stream and the audio stream and operation module performing the upsampling on the decoded first video stream in the second decoder, when computation of the first video stream is larger than computation of the second video stream.

17. The method of claim 14, wherein the selectively performing performs the operation module decoding each of the first video stream and the audio stream and the operation module performing the upsampling on the decoded first video stream in the first decoder and performs the operation module decoding the second video stream in the second decoder, when computation of the second video stream is larger than computation of the first video stream.

18. The method of claim 11, wherein the first video stream is a base layer stream received through a Ku transmission band and the second video stream is an enhancement layer stream received through a Ka transmission band.

19. The method of claim 18, wherein the selecting performs the operation module decoding the first video stream in the first decoder and the operation module decoding the audio stream and performs the operation module performing the upsampling on the decoded first video stream in the second decoder, when the reception of the second transmission stream is interrupted by attenuation of the Ka transmission band.
